(19) United States
(12) Patent Application Publication
(10) Pub. No.: US 2008/0266089 A1
(43) Pub. Date: Oct. 30, 2008

(54) Electronic device security system and method

(76) Inventors: Edgar Diego Haren, Houston, TX (US); Ann J. Lai, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/799,186

(22) Filed: Apr. 30, 2007

(51) Int. Cl. G08B 13/14

(52) U.S. Cl. 340/568.1

(57) ABSTRACT

An electronic devices security method comprising, responsive to detecting at least one event indicating a possible theft of an electronic device, initiating an alarm at a docking station associated with the electronic device

### BACKGROUND

Security solutions for a laptop computer do not adequately prevent laptop computers from physically being stolen. Data security protocols only protect the actual data stored in the laptop and not the physical laptop computer itself. On the other hand, physical security solutions, such as a cable lock, are easily broken or cut. Furthermore, audible alarms are typically dependent on the power source of the laptop computer. Therefore, thieves need only to unplug the laptop computer or disconnect a battery source to deactivate the alarm.

### BRIEF DESCRIPTION OF THE DRAWINGS

FIG. 1 illustrates an embodiment of an electronic device security system;

FIG. 2 is a block diagram of an electronic device security system; and

FIG. 3 is a flowchart depicting an embodiment of a an electronic device security method.

### DETAILED DESCRIPTION OF THE DRAWINGS

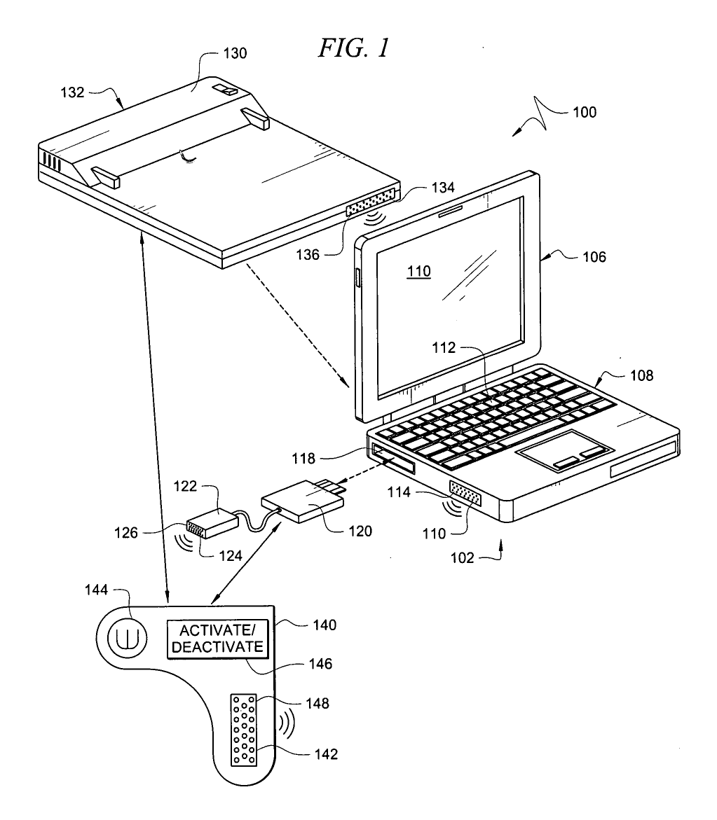

FIG. 1 illustrates an embodiment of a security system 100 for an electronic device 102. In some embodiments, security system 100 utilizes a combination of wired and wireless communications. Security system 100 is a system for detecting and substantially preventing theft of electronic device 102. In the illustrative embodiment, security system 100 comprises a docking station 130 for electronic device 102, a card 120, and a remote device 140. Electronic device 102, card 120, docking station 130, and remote device 140 can use any communications protocol to communicate with each other, such as, but not limited to, infrared, radio frequency, Bluetooth®, Wi-Fi®, and ultrawide band. (Bluetooth® is a registered trademark of Bluetooth Sig, Inc. in the United States of America and possibly other countries. Wi-Fi® is a registered trademark of the Wi-Fi Alliance in the United States and possibly other countries.) Furthermore, electronic device 102, card 120, docking station 130, and remote device 140 determine which devices to communicate with using an enumeration process. An enumeration registration process pairs electronic device 102 with the other devices in security system 100 (e.g., card 120, docking station 130, and remote device 140). In essence, electronic device 102 maintains a list of identification tags for each of card 120, docking station 130, and remote device 140. Alternatively, card 120, docking station 130, and remote device 140 can also store the identification tag for the other devices in security system 100. It should be noted, however, that security system 100 can use any other type of registration process to identify with which devices to communicate.

In FIG. 1, electronic device 102 is a laptop or notebook computer 104. However, it should be understood that electronic device 102 can be any type of portable device (e.g., a personal digital assistant (PDA), MP3 player, a hands-free device, or a gaming device). In FIG. 1, electronic device 102 comprises a display member 106 rotably coupled to a base member 108. Display member 106 comprises a display screen 110. Base member 108 comprises a keyboard 112, an input/output (I/O) device 114, and a slot 118. In FIG. 1, I/O device 114 comprises a speaker 116 and is configured to emanate an alarm in response to an event indicating a potential theft of electronic device 102. It should be noted, however, that I/O device 114 can comprise one and/or more types of audible, visual, and/or tactile alarms (e.g., a series of audible tones or beeps, a song, a voice message stating, for example, “electronic device missing” or “warning”, a flashing light, or a vibration). In the illustrated embodiment, I/O device 114 is disposed along an external edge of a housing 104; however, it should be noted that I/O device 114 can be disposed along any edge or surface display member 106 and/or base member 108.

In FIG. 1, slot 118 is disposed along the same edge as I/O device 114. Slot 118 enables card 120 to slide into and be engagably coupled to electronic device 102. It should be noted, however, that slot 118 can be disposed along any edge or surface of display member 106 and/or base member 108 and can be disposed on a different edge or surface as I/O device 114. Card 120 can be any type of card (e.g., a Personal Computer Memory Card International Association (PCMCIA) card or an ExpressCard) which can interface with electronic device 102.

Card 120 comprises a dongle 122 and an I/O device 124. Dongle 122 is configured to be an electronic tether for electronic device 102, thereby configured to detect at least one event which may indicate that electronic device 102 is being stolen. For example, dongle 122 detects whether electronic device 102 has moved beyond a predetermined distance away from docking station 130. As another example, dongle 122 also detects whether electronic device 102 is turned and/or is being carried at an angle other than a predetermined angle (e.g., an angle representing a stationary, in-use position and/or orientation of electronic device 100). In yet another example, dongle 122 detects whether card 120 is decoupled from electronic device 102.

In some embodiments, I/O device 124 for card 120 comprises a speaker 126 disposed along an external edge of dongle 122. I/O device 124 is configured to emanate an alarm in response to dongle 122 detecting an event indicating a potential theft of electronic device 102. I/O device 124 can be disposed along any external edge and/or surface of dongle 122 and can emanate one and/or more types of alarms (e.g., audible, visual, and/or tactile). In an alternative embodiment, the features and/or functions of card 120 may be disposed in and/or otherwise included as part of electronic device 102 (e.g., an internal chipset embedded within electronic device 100).

Docking station 130 communicatively and removably couples to electronic device 102 and provides additional functionality to a user for electronic device 102. Docking station 130 may comprise any type of device that provides additional connections (e.g., slots for expansion cards, bays for storage devices, power, and connectors for peripheral devices, such as a keyboard, printer, monitor, or mouse) for electronic device 102. In the illustrative embodiment, docking station 130 comprises a housing 132 enclosing a portion of the electronic components for docking station 130. I/O device 134 is disposed on an external edge of housing 132 and comprises a speaker 136. I/O device 134 is configured to emanate one or more types of alarms. I/O device 134 can be disposed along any edge or surface of housing 132. In an alternative embodiment, the features and/or functions of docking station 130 may be disposed in and/or otherwise included as part of electronic device 102.

Remote device 140 is a hand-held electronic device in which a user can easily carry around and/or in which a user can attach to a clothing item worn by the user. In the illustrated embodiment, remote device 140 is a key fob. However, it should be noted that remote device 140 can be any type of portable electronic device with the capability of bi-directionally receiving and transmitting instructions (e.g., a PDA or a cellular phone). Remote device 140 comprises an I/O device 142, power button 144, and an activate/deactivate button 146. I/O device 142 notifies a user of a potential theft of electronic device 102. I/O device 142 comprises speaker 148 and is configured to emanate one or more types of alarms. Power button 144 turns remote device 140 on or off. Activate/deactivate button 144 enables a user to wirelessly activate and/or deactivate I/O devices 114, 124, 134, and 142.

Thus, in application, security system 100 wirelessly initiates one or more security modules 114, 124, 134, and 142 in response to an event indicating a possible theft of electronic device 102. Thus, security system 100 comprises an activated alarm at one or more of electronic device 102, dongle 122, docking station 130, and remote device 140. In the illustrative embodiments, remote device 140 can wirelessly deactivate and activate the alarms for electronic device 102, dongle 122, docking station 130, and remote device 140.

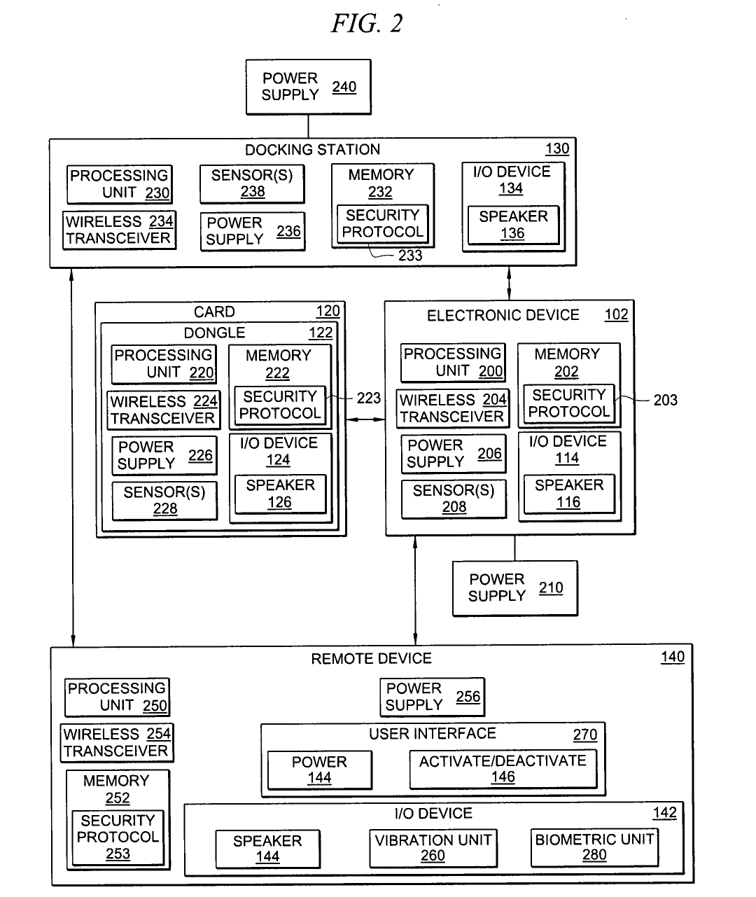

FIG. 2 is a block diagram of security system 100 in which embodiments may be implemented. All devices illustrated in security system 100 are a combination of software and hardware embodiments. However, in alternative embodiments, the devices may be a software-only or a hardware-only embodiment.

In the illustrated embodiment, electronic device 102 comprises I/O device 114, a processor unit 200, a memory 202, a wireless transceiver 204, a power supply 206, and sensor(s) 208. I/O device 114 comprises speaker 116 which emanates in response to an event indicating a potential theft of electronic device 102. It should be noted, however, that I/O device 114 can comprise other types of alarm devices (e.g., a flashing light or a vibration unit). Processor unit 200 is a set of one or more processors which executes security protocol 203 stored in memory 202. Security protocol 203 comprises the transmission of an electrical signal (e.g., a wave file, a siren or a voice) which initiates speaker 116 in I/O device 114. Wireless transceiver 204 is any device (e.g., an antenna) which receives and transmits signals for any electronic device (e.g., card 120, remote device 140, or docking station 130) in security system 100. Power supply 206 supplies a current to I/O device 114 in the event that an external power supply 210 is decoupled from electronic device 102. External power supply 210 is coupled to electronic device 102 and can be implemented in a number of forms, such as, but not limited to, a battery or power cord coupled to a power outlet. Power supply 206 can be any type of device which provides enough current or power to activate I/O device 114 such as, but not limited to, an internal battery or an inductor. Sensor(s) 208 are one or more transducers or other types of elements which detect an event indicating a theft of electronic device 102. Specifically, for electronic device 102, sensor(s) 208 identifies a loss of connectivity between external power supply 210 and electronic device 102. In the illustrated embodiment, sensor(s) 208 are coupled to a switch in the power circuit of electronic device 102. In this example, if no current or a disruption in the flow of current between electronic device 102 and the power source is sensed, then sensor(s) 208 trigger the switch and the flow of current is changed. The change in current activates power supply 206 and initiates security protocol 203. Security protocol 203 then causes an electronic alarm signal to be transmitted to speaker 116, which subsequently emanates an audible alarm through electronic device 102. Security protocol 203 also causes an alarm signal to be transmitted via wireless transceiver 204 to I/O devices 124, 134, and 142. Alternatively, instead of hardwiring a switch to external power supply 210 and electronic device 102, sensor(s) 208 can detect a change of current flow in electronic device 102 using a software-based identification and then utilize the set of instructions of security protocol 203.

Card 120 comprises dongle 122 which comprises I/O device 124, a processing unit 220, a memory 222, a wireless transceiver 224, power supply 226, and sensor(s) 228. It should be noted, however, that any of the components in dongle 122 be omitted, and instead, be disposed elsewhere in card 120. I/O device 124 comprises speaker 126 which emanates in response to an event indicating a potential theft of electronic device 102. However, it should be noted that I/O device 114 can comprise other types of alarm devices (e.g., a flashing light or a vibration unit). Processing unit 220 is a set of one or more processors that execute a security protocol 223 stored in memory 222. Security protocol 223 for card 120 identifies one or more of: (1) the distance between electronic device 102 and docking station 130 being beyond a predetermined distance; (2) electronic device 102 being positioned and or oriented at a different angle than a predetermined angle; and (3) a loss of connectivity existing between card 120 and electronic device 102. Power supply 226 supplies a current to I/O device 124 in the event that card 120 is decoupled from electronic device 102.

Sensor(s) 228 are one or more transducers or other types of elements used to detect when remote device 140 is located beyond a proximate distance away from electronic device 102. The predetermined distance between electronic device 102 and docking station 130 is a distance identified and set by a user, an administrator of electronic device 102, or the manufacturer of electronic device 102. In some embodiments, sensor(s) 228 comprise proximity sensor(s) which identifies a signal between wireless transceiver 224 and remote device 140. Once the signal is lost, security protocol 223 is initiated which causes an electronic alarm signal to be transmitted to speaker 126. Speaker 126 subsequently emanates an audible alarm. Security protocol 223 also causes an alarm signal to be transmitted via wireless transceiver 224 to I/O devices 114, 134, and 142.

In the embodiment illustrated, sensor(s) 228 also detect electronic device 102 being positioned and/or oriented at a particular angle. In some embodiments, sensor(s) 228 are coupled to an electronic device (e.g., an accelerometer or a gyroscope) to measure the angle of electronic device 102 relative to a horizontal plane. Sensor(s) 228 identify whether electronic device 102 is different than a predetermined angle, which is identified and set by a user, an administrator of electronic device 102, or the manufacturer of electronic device 102.

In the embodiment illustrated, sensor(s) 228 also detect a decoupling of card 120 from electronic device 120. In some embodiments, sensor(s) 228 are coupled to a switch in the power circuit of card 120. If no current or a disruption in the flow of current between card 120 and electronic device 102 is sensed by sensor(s) 228, sensor(s) 228 trigger the switch and a change in flow of current initiates power supply 226 of I/O device 114. The initiation of power supply 226 also activates security protocol 223. Alternatively, instead of hardwiring a switch, sensor(s) 228 can detect a change of current flow in card 120 using a software-based identification and then utilize the set of instructions to activate security protocol 223.

Docking station 130 comprises a I/O device 134, a processing unit 230, a memory 232, a wireless transceiver 234, a power supply 236, and sensor(s) 238. I/O device 134 comprises speaker 134 configured to emanate an alarm in response to identifying an event indicating a potential theft of electronic device 102. Processing unit 230 is a set of one or more processors which executes a security protocol 233 stored in memory 232. In docking station 130, security protocol 233 identifies a loss of connectivity between docking station 130 and an external power supply 240. External power supply 240 can implemented in a number of forms, including, but not limited to, a battery or a power cord coupled to a power outlet. Power supply 236 supplies a current to I/O device 134 in the event that external power supply 240 is decoupled from docking station 130. Wireless transceiver 234 is any device (e.g., an antenna) which receives and transmits signals for any electronic device (e.g., card 120, electronic device 130, or remote device 140) in security system 100. Power supply 236 supplies a current to I/O device 134 in the event that an external power supply 240 is decoupled from docking station 240. Power supply 236 can be any type of device which provides enough current or power to activate I/O device 114 such as, but not limited to, an internal battery or an inductor. Sensor(s) 238 one or more transducers or other types of elements which detect an event indicating a theft of electronic device 102. Sensor(s) 238 are coupled to a switch and a change in flow of the current between power supply 240 and docking station 130 initiates power supply 236. The initiation of power supply 236 initiates security protocol 233. Security protocol 233 then causes an electronic alarm signal to be transmitted to speaker 136, which subsequently emanates an audible alarm through docking station 130. Security protocol 233 also causes an alarm signal to be transmitted via wireless transceiver 234 to I/O devices 104, 124, and 142. Alternatively, instead of hardwiring a switch, sensor(s) 238 can detect a change of current flow in docking station 130 using a software-based identification and then utilize the set of instructions to activate security protocol 233.

Remote device 140 comprises I/O device 142, a processing unit 250, a memory 252, a wireless transceiver 254, a power supply 256, and an user interface 270. I/O device 142 comprises speaker 144, a vibration unit 260, and a biometric unit 280. Speaker 144 and/or vibration unit 266 generate an alarm in response to an event indicating a potential theft of electronic device 102. Vibration unit 266 can be any system and/or device (e.g., an electronic motor coupled to an unbalanced mass) which generates a vibration. Biometric unit 280 is any device which recognizes a particular user based on one or more physical traits of the user. Biometric unit 280 can be, for example, but not limited to, a thumbprint scanner, a breathalyzer, or a retina scanner. In the illustrated embodiment, biometric unit 280 is configured for a particular user to enable the user to remotely activate and/or deactivate the alarms for electronic device 102, card 120, docking station 130, and remote device 144. Thus, in response to remote device 140 emanating an alarm, biometric unit 280 identifies/authenticates the user and then enables the user to deactivate the alarms. In alternative embodiments, biometric unit 280 may be omitted from remote device 140. Furthermore, in alternative embodiments, one or more of electronic device 102, card 120, and docking station 130 may comprise a biometric unit configured to limit access to data stored in memory 202 and to activate and/or deactivate I/O device 114, 124, or 134. Processing unit 250 is a set of one or more processing units which execute a security protocol 253 for remote device 140 stored in memory 252. Wireless transceiver 254 is any device (e.g., an antenna) which receives and transmits signals from electronic device 102, card 120, and docking station 130.

Thus, in application, electronic device 102, card 120, and docking station monitor for any event which may indicate a potential theft of electronic device 102. The events which may indicate a potential theft include, but are not limited to: (1) the distance between electronic device 102 and docking station 130 being outside a predetermined distance; (2) the angle of electronic device 102 being different than a predetermined angle; (3) a loss of connectivity existing between external power source 210 and electronic device 102; (4) a loss of connectivity existing between card 120 and electronic device 102; or (5) a loss of connectivity between docking station 130 and power supply 240. If one or more of the preceding events occur, then the corresponding security protocol (e.g., security protocols 203, 223, or 233) for device (e.g., electronic device 102, card 120, and docking station 130) initiates an alarm within the individual device. The corresponding security module then transmits the alarm to the other devices (e.g., electronic device 102, card 120, docking station 130, and remote device 140), thereby initiating an alarm in the respective device. Thus, for example, if electronic device 102 identifies that external power supply 210 is decoupled from electronic device 102, then processing unit 200 transmits an electronic signal to speaker 116 to emanate an alarm for electronic device 102. Electronic device 102 also transmits a signal to one or more of card 120, docking station 130, and remote device 140 to initiate the alarms in the respective devices. In another example, if card 120 identifies that electronic device 102 is moved outside the predetermined distance, then processing unit 220 transmits an electronic signal to speaker 126 while also transmitting a signal to one or more of electronic device 102, docking station 130, and remote device 140. Each device then initiates the security protocols within each device and initiate the alarms for each device.

In one embodiment, the alarm for each device is triggered in response to the identification of a potential theft event. In an alternative embodiment, the alarms for only some of the devices are triggered in response to the identification of the theft event. For example, if card 120 is still coupled to electronic device 102, processing unit 220 may not trigger the alarm in dongle 122, and instead, only have electronic device 102 emanate an audible alarm. In another example, if electronic device 102 is still coupled to docking station 130 when the theft event is identified, processing unit 230 may not initiate the alarm in docking station 130, and instead, only have electronic device 102 emanate an audible alarm.

In response to receiving an alarm in remote 144, the user determines whether the alarm is a true or false alarm. If the alarms are false alarms, the user pushes activate/deactivate button 146 to turn off the alarms. If the alarms are true alarms, then the user can take appropriate measures to either report the matter to the appropriate authorities, apprehend the thief, or physically secure electronic device 102.

In an alternative embodiment, security system 100 can also notify a remote central security system, a user of another electronic device, or another contact listed in electronic device 102. For example, electronic device 102 can transmit an electronic message (email) or an instant message (IM) to a desktop computer, a cellular phone, or a personal digital assistant (PDA) indicating that theft may be occurring with regard to electronic device 102.

In yet another embodiment, in response to the alarm being a true alarm, electronic device 102 can secure and lock down all data stored within electronic device 102. The data can be unlocked by deactivating the alarm, entering a password, or using biometric unit 280. The method of unlocking can be designated by the user or administrator of electronic device 102. The method of deactivation can also be a default setting. The method of unlocking can include more than method, and, depending on implementation, the user can unlock electronic device 102 directly using any one of or all of docking station 110, electronic device 102, or remote device 130.

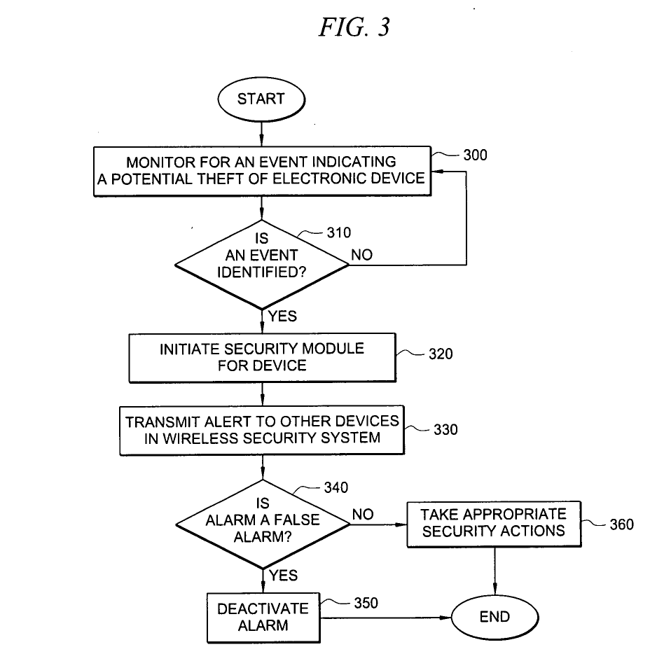

FIG. 3 is a flowchart depicting an embodiment of a method for wirelessly securing electronic device 102. The method begins with block 300 in which security system 100 monitors for an event indicating a potential theft of electronic device 102. An event indicating a potential theft of electronic device 100 occurs if one or more of the following occurs: (1) the distance between electronic device 102 and docking station 130 is outside a predetermined distance; (2) the angle of electronic device 102 being different than a predetermined angle; (3) a loss of connectivity exists between external power source 210 and electronic device 102; (4) a loss of connectivity exists between card 120 and electronic device 102; or (5) a loss of connectivity between docking station 130 and power supply 240.

Security system 100 then determines whether an event is identified (block 310). If an event is not identified (“no” output to block 310), the method returns to block 300. If, however, an event is identified (“yes” output to block 310), the device identifying the event initiates the device's own security protocol (block 320). The device causes an alarm signal to be transmitted to the other devices in security system 100 (block 330). The alarm signal causes the other devices to initiate their respective security protocols.

Security system 100 then determines whether the alarm is a true or false alarm (block 340). If the alarm is a false alarm (“yes” output to block 340), then the user deactivates the alarm using remote device 140 (block 350), with the method terminating thereafter. If the alarm is a true alarm (“no” output to block 340), then the user can take appropriate security action, including, but not limited to, reporting the matter to the appropriate authorities, apprehending the thief, or physically securing electronic device 102 (block 360). The method terminates thereafter.

The illustrative embodiments may be implemented in software and can be adapted to run on different platforms and operating systems. In particular, functions implemented by electronic device 102, for example, may be provided by an ordered listing of executable instructions that can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate or transport the program for use by or in connection with the instruction execution system, apparatus, or device. The computer readable medium can be, for example, but is not limited to, an electronic, magnetic, optical, electro-magnetic, infrared, or semi-conductor system, apparatus, device, or propagation medium.

The illustrative embodiments provide security system 100 that wirelessly secures the electronic device 102. Security system 100 emanates alarm at the user, at electronic device 102 itself, as well as docking station 130 where the user was using electronic device 102. Furthermore, the illustrative embodiments allows for a user to remotely activate and deactivate an alarm. The illustrative embodiments also provide a mechanism to notify other individuals (e.g., someone stored in a contact list in the electronic device 102) and devices outside of security system 100. Moreover, the illustrative embodiments allow for data stored within electronic device 102 to be protected using biometric unit 280.

What is claimed is:

1. An electronic device security method, comprising:
responsive to detecting at least one event indicating a possible theft of an electronic device, initiating an alarm at a docking station associated with the electronic device.

2. The method of claim 1, further comprising, responsive to detecting the at least one event, initiating an alarm of the electronic device.

3. The method of claim 1, further comprising, responsive to detecting the at least one event, initiating an alarm in a remote device.

4. The method of claim 1, wherein detecting the at least one event comprises identifying movement of the electronic device beyond a predetermined distance relative to the docking station.

5. The method of claim 1, wherein detecting the at least one event comprises identifying an angle of electronic device different than a predetermined angle.

6. The method of claim 1, wherein detecting the at least one event comprises identifying decoupling of a power source from the electronic device.

7. The method of claim 1, wherein detecting the at least one event comprises identifying decoupling of a card coupled to the electronic device.

8. The method of claim 1, further comprising wirelessly deactivating, by a remote device, the alarm at the docking station.

9. A docking station, comprising:
a security protocol configured to initiate an alarm in response to detecting at least one event indicating a possible theft of an electronic device associated with the docking station.

10. The docking station of claim 9, wherein the docking station is configured to cause an alarm to be activated in the electronic device.

11. The docking station of claim 9, wherein the docking station is configured to cause an alarm to be activated in remote device.

12. The docking station of claim 9, further comprising at least one sensor to detect movement of the electronic device beyond a predetermined distance relative to the docking station as the at least one event.

13. The docking station of claim 9, further comprising at least one sensor to detect decoupling of a power source from the docking station as the at least one event.

14. The docking station of claim 9, further comprising a wireless transceiver configured to receive a signal indicating an angle of the electronic device different than a predetermined angle.

15. The docking station of claim 9, further comprising a wireless transceiver configured to receive a signal indicating decoupling of a power source from the electronic device.

16. The docking station of claim 9, further comprising a wireless transceiver configured to receive a signal identifying decoupling of a card coupled to the electronic device.

17. A remote device comprising:
a deactivation interface configured to wirelessly deactivate an alarm initiated at a docking station, wherein the alarm is initiated in response to detecting at least one event associated with a potential theft of electronic device.

18. The remote device of claim 17, wherein the deactivation interface is further configured to deactivate an alarm initiated at the electronic device.

19. The remote device of claim 17, wherein the deactivation interface is further configured to deactivate an alarm initiated in a remote device.

20. The remote device of claim 17, wherein the remote device is a key fob.
